(19) United States
(12) Patent Application Publication
(10) Pub. No.: US 2006/0045083 A1
(43) Pub. Date: Mar. 2, 2006

(54) System and method for enabling the coexistence of non-802.11 waveforms in the presence of 802.11 compliant waveforms in a communication network

(75) Inventors: William Vann Hasty JR., Lake Mary, FL (US); Pertti O. Alapuranen, Deltona, FL (US)

Correspondence Address: GARDNER CARTON & DOUGLAS LLP;(MESHNETWORKS/MOTOROLA) ATTN: PATENT DOCKET DEPT., 191 NORTH WACKER DRIVE, SUITE 3700, CHICAGO, IL, 60606-1698, US

(73) Assignee: MeshNetworks, Inc., Maitland, FL (US)

(21) Appl. No.: 11/210,952

(22) Filed: Aug. 24, 2005

Related U.S. Application Data
(60) Provisional application No. 60/604,048, filed on Aug. 25, 2004.

(51) Int. Cl. H04L 12/56; H04L 12/28

(52) U.S. Cl. 370/389

(57) ABSTRACT

A system and method for enabling the coexistence of waveforms that do not comply with IEEE Standard 802.11 in the presence of 802.11 compliant waveforms in a wireless communication network (100), in particular, a wireless multi-hopping ad-hoc peer-to-peer communication network (100). More particularly, the system and method controls 802.11 compliant devices (102, 106, 106) in the communication network to refrain from accessing a transmission medium for a predetermined time so that communication not complying with 802.11 can be performed, such as transmission of signals between devices (102, 106, 107) to perform time-of-flight measurements.

This application claims the benefit of U.S. Provisional Application No. 60/604,048, filed Aug. 25, 2004, the entire content being incorporated herein by reference.

### FIELD OF THE INVENTION

The present invention relates in general to wireless communication networks and in particular to a system and method for enabling the coexistence of non-compliant and compliant 802.11 waveforms in a wireless communication network.

### BACKGROUND

In recent years, a type of mobile communications network known as an “ad-hoc” network has been developed. In this type of network, each mobile node is capable of operating as a router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, now U.S. Pat. No. 6,807,165, and in U.S. patent application Ser. No. 09/815,164 entitled “Prioritized-Routing for an Ad-Hoc, Peer-to-Peer, Mobile Radio Access System”, filed on Mar. 22, 2001, now U.S. Pat. No. 6,873,839, the entire content of each being incorporated herein by reference.

As can be appreciated by one skilled in the art, these ad-hoc networks described above can employ technology that complies with the Institute of Electrical and Electronic Engineers (IEEE) Standard 802.11, which is also referred to herein as “802.11” (as in, for example, “802.11 compliant” or “complying with 802.11”). The IEEE Standard 802.11, divides the functional layers of the ad-hoc network into a Medium Access Control (MAC) Layer and a Physical (PHY) Layer. The MAC is the basis for all of the amended standards that extend 802.11 with the addition of different physical layers (PHYs). Furthermore, the PHYs are divided into the Physical Layer Convergence Protocol (PLCP) and the Physical Medium Dependent (PMD) sublayers. Data is transmitted between devices in the ad-hoc network in the form of packets.

Although a common PLCP header is present in data packets complying to the IEEE Standard 802.11(a), 802.11(b) and 802.11(g) PLCP specifications, the base IEEE 802.11 specification does not set forth the same PLCP header specification or processing rules as do the IEEE 802.11(a), 802.11(b) and 802.11(g) specifications, which are also referred to herein simply as “802.11(a)”, “802.11(b)” and “802.11(g)”, for example. Details of these specifications are set forth in the following documents, which are examples of the version of the IEEE specifications referenced herein: Standard for Information Technology—Telecommunications and information exchange between systems—Local and Metropolitan Area networks—Specific requirements—Part 11: Wireless LAN Medium Access Control (MAC) and Physical Layer (PHY) specifications. IEEE-8802-11-1999; IEEE Standard for Telecommunications and Information Exchange Between Systems—LAN/MAN Specific Requirements—Part 11: Wireless Medium Access Control (MAC) and physical layer (PHY) specifications: High Speed Physical Layer in the 5 GHz band. IEEE-8802-11a-1999; IEEE Standard for Information Technology—Telecommunications and information exchange between systems—Local and Metropolitan networks—Specific requirements—Part 11: Wireless LAN Medium Access Control (MAC) and Physical Layer (PHY) specifications: Higher Speed Physical Layer (PHY) Extension in the 2.4 GHz band. IEEE-8802-11b-1999; and IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications: Further Higher Data Rate Extension in the 2.4 GHz Band. IEEE-8802-11g-2003, the entire contents of each of these documents being incorporated herein by reference.

For example, the PLCP rules for 802.11(a), 802.11(b) and 802.11(g) require that a MAC Layer complying with 802.11 abstain from accessing the transmission medium while the clear channel assessment function of the 802.11 PHY Layers indicate a busy medium. Therefore, successful reception of the PLCP header will cause these PHY Layers to indicate a busy medium until the expiration of a period of time that is specified in the PLCP header. This period of time is the time necessary to successfully receive the entire packet following the PLCP header. Hence, even if the carrier is lost or interrupted after the successful reception of the PLCP header, the receiving PHY Layer will indicate a busy medium to the MAC Layer, thus preventing the MAC Layer from accessing the current channel until the expiration of the specified period of time. Accordingly, the device or devices that received the PLCP header will not attempt transmission over the channel until the period of time has elapsed.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communications network including a plurality of nodes employing a system and method in accordance with an embodiment of the present invention;

FIG. 2 is a block diagram illustrating an example of a mobile node employed in the network shown in FIG. 1;

FIG. 3 is a diagram illustrating the fields specific to a PHY header as specified in the 802.11(b) specification; and

FIG. 4 is a diagram illustrating the fields specific to a PHY header as specified in the 802.11(a) specification.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system and method for enabling the coexistence of waveforms that do not comply a particular protocol, such as the IEEE Standard 802.11, in the presence of signals that do comply with that particular protocol, such as 802.11 compliant waveforms, in a wireless communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system and method for enabling the coexistence of waveforms that do not comply with IEEE Standard 802.11 in the presence of 802.11 compliant waveforms in a wireless communication network as described herein. The non-processor circuits may include, but are not limited to, a radio receiver, a radio transmitter, signal drivers, clock circuits, power source circuits, and user input devices. As such, these functions may be interpreted as steps of a method to perform operations for enabling the coexistence of waveforms that do not comply with IEEE Standard 802.11 in the presence of 802.11 compliant waveforms in a wireless communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As described in more detail below, an embodiment of the present invention provides a system and method for enabling the coexistence of waveforms that do not comply with IEEE Standard 802.11 in the presence of 802.11 compliant waveforms in a wireless communication network, in particular, a wireless multi-hopping ad-hoc peer-to-peer communication network. Specifically, the system and method controls 802.11 compliant devices in the communication network to refrain from accessing a medium for 802.11 compliant transmission for a predetermined time to enable a device in the network to transmit and receive signals not complying with 802.11, such as signals that are transmitted between the device and other devices to enable the device to perform time-of-flight measurements, without the risk of those non-compliant signals colliding with 802.11 compliant signals being transmitted from other devices.

In order to achieve this functionality, the system and method controls a device in the communication network to transmit a PHY header according to the normal transmission rules such as those outlined in IEEE 802.11, 802.11(a), 802.11(b) and 802.11(g), and to refrain from transmitting the indicated MAC and data portion of an 802.11 compliant frame immediately after the PHY header. Instead, the device transmits a waveform not complying with 802.11 immediately after the PHY header for a period of time not to exceed the duration indicated in the PLCP header of the PHY header. Successful reception and decoding of the PHY header by any 802.11 compliant device will thus cause those 802.11 compliant devices to refrain from accessing the medium for the duration of time indicated in the PLCP header. That is, any 802.11 compliant device that has successfully received the PHY header and is within the broadcast range of the device that transmitted the non-compliant waveform will not transmit any 802.11 compliant waveforms on the transmission medium during the indicated duration of time. Accordingly, the non-802.11 waveforms can be transmitted on the transmission medium without the chance of collision with an 802.11 compliant waveform from another device, and a device can therefore use these non-802.11 waveforms to perform, for example, time-of-flight ranging or other desired functionality.

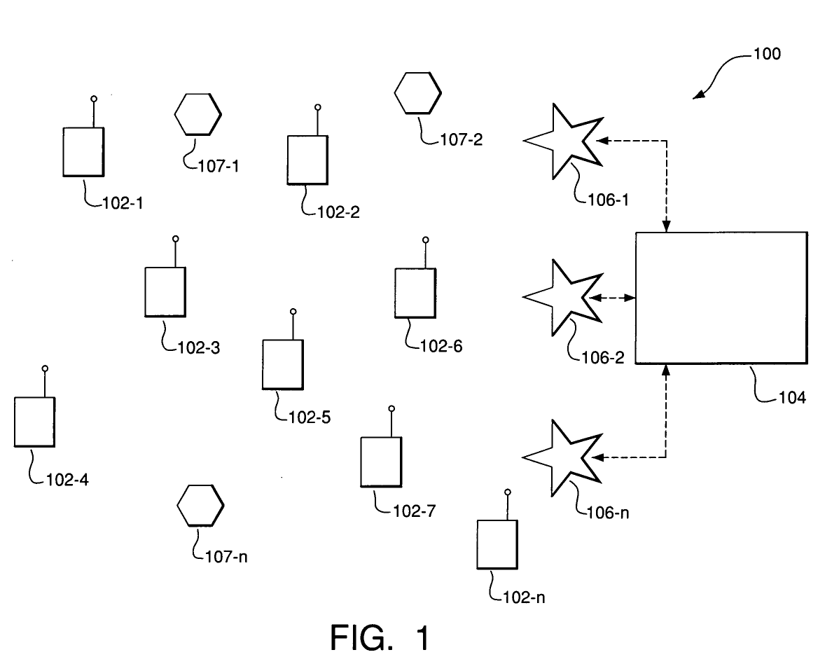

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. Pat. No. 5,943,322 to Mayor, incorporated by reference herein, and in U.S. patent application Ser. No. 09/897,790, and U.S. Pat. Nos. 6,807,165 and 6,873,839, referenced above.

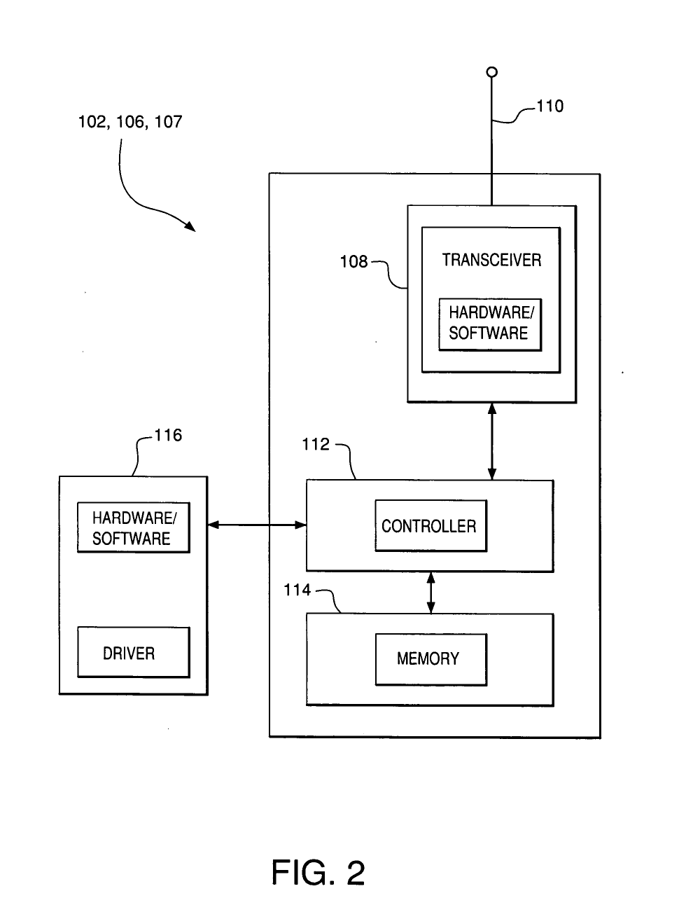

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As discussed briefly above, ad-hoc network 100 can employ technology that complies with IEEE Standard 802.11, as well as 802.11(a), 802.11(b) and 802.11(g). As further discussed above, in such a network 100, a problem can arise because the 802.11(a), 802.11(b) and 802.11(g) specifications require that a MAC Layer complying to 802.11 abstain from accessing the transmission medium while the clear channel assessment function of the 802.11 PHY Layers indicate a busy transmission medium. Therefore, successful reception of the PLCP header will cause these PHY Layers to indicate a busy transmission medium until the expiration of a period of time that is specified in the PLCP header even if the carrier is lost or interrupted after the successful reception of the PLCP header.

In order to avoid this and other potential problems, a system and method according to an embodiment of the present invention has been developed which enables nodes 102, 106 and 107 to transmit and receive waveforms that do not comply with 802.11 specifications using 802.11 compliant MAC and PHYs. Specifically, this is achieved by controlling a node, for example, a mobile node 102 desiring to perform ranging measurements, to transmit a PHY Layer header (referred to as a “PHY header”) according to the normal transmission rules outlined in 802.11, 802.11(a), 802.11(b) and 802.11(g) and to refrain from transmitting the indicated MAC Layer header (referred to as “MAC header”) and data portion of an 802.11 compliant frame immediately after the PHY header. Accordingly, the node 102 can then transmit waveforms not complying with 802.11 specifications to perform the ranging measurements within the time period indicated in the PLCP header of the PHY header during which other nodes within the broadcast range of node 102 that receive the PHY header will refrain from transmitting 802.11 compliant messages over the transmission medium.

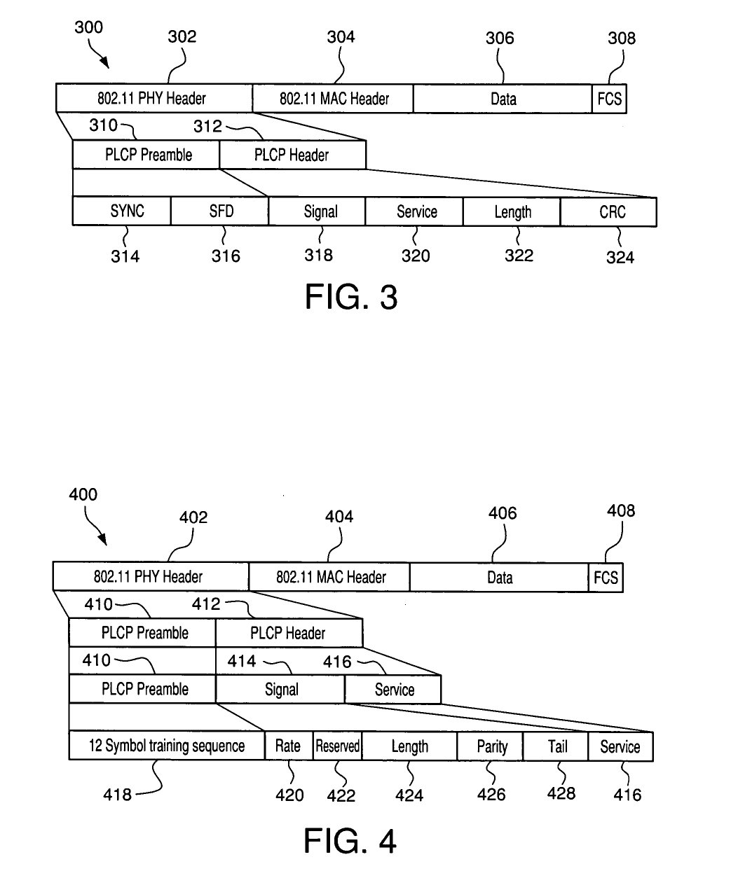

FIG. 3 shows an example of a data packet frame 300, including a PHY header 302, MAC header 304, data portion 306, and frame check sequence (FCS) field 308, and the fields of an 802.11 PHY header 302, and the components of the PLCP preamble 310 and PLCP header 312 of the PHY header 302 as set forth in the 802.11(b) specification. As indicated, the PLCP preamble 310 specifies a synchronization (SYNC) field 314 and a start-of-frame delimeter (SFD) field 316, and the PLCP header specifies a SIGNAL field 318 which includes information pertaining to the signal such as data rate, SERVICE field 320 indicating the type of service for the frame, a LENGTH field 322 indicating the length of the frame, and cyclic redundancy check (CRC) field 324. The LENGTH field 322 gives a measure in microseconds of the intended duration of the packet transmission including the time necessary to transmit the PHY header 302 and MAC header 304 and the data portion 306 of the packet regardless of the PHY specific PMD used. Section 18.2.3.5 of the 802.11(b) specification defines the content of the length field as the number of microseconds required to transmit the entire frame 300 (including PHY header 302, MAC header 304, data portion 306, and FCS 308). Section 18.2.6 of the 802.11(b) specification specifies that PHY Layer shall indicate a busy transmission medium for the duration value of the Length field if the PLCP header 302 is successfully received, decoded and verified with the included CRC 324. In the event of any error condition that would terminate the reception of the remainder of the frame, the PHY Layer will continue to indicate a busy transmission medium to the MAC Layer for the remainder of the duration specified in the Length field. The effect of the PHY's indication of busy transmission medium is to prevent the MAC Layer from performing any channel access until the expiration of the busy transmission medium indication.

FIG. 4 illustrates an example of data packet frame 400 as set forth in the 802.11(a) specification. As indicted, the data packet frame 400 includes a PHY header 402, MAC header 404, data portion 406, and FCS 408. FIG. 4 further illustrates the fields of the 802.11 PHY header 402, and the components of the PLCP preamble 410 and PLCP header 412 of the PHY header 402 as set forth in the 802.11(a) specification. As indicated, the PLCP header 412 specifies a SIGNAL field 414 and a SERVICE field 416. The PLCP preamble 410 in this example includes 12 symbol training sequence bits 418, and the SIGNAL field 414 contains the RATE field 420 indicating the data rata, a RESERVED field 422 which can be reserved for additional information bits, a LENGTH field 424, a PARITY field 426 including parity bits, and a TAIL field 428 including tail bits. Section 17.3.4.2 of the 802.11(a) specification states that the LENGTH field 424 indicates the number of octets that the MAC Layer is requesting the PHY Layer to transmit. Section 17.3.12 of the 802.11(a) specification outlines the PLCP receive procedure. Upon successful reception of the PLCP header 412, the PHY layer reserves the transmission medium for a period of time it would take to complete reception of the indicated frame. This duration is computed from the number of octets in the LENGTH field 424 and the time required to transmit the indicated number of octets at the data rate indicated in the RATE field 420. The 802.11(a) specification requires that the transmission medium be reserved as busy for the entire duration regardless of any error condition after the PLCP header 412 has been successfully received and decoded. The PHY Layer will indicate a busy channel to the upper MAC Layer. This busy indication will prevent the MAC Layer from attempting a channel access until the busy indication duration expires.

The following example will be discussed with regard to a data packet frame 400 as shown in FIG. 4. However, similar operations can be performed with regard to a data packet frame 300 as shown in FIG. 3.

In accordance with an embodiment of the present invention, if it is desirable for a node, for example, a mobile node 102, to use the period of time designed in the LENGTH field 424 of the transmission for transmission other than 802.11 compliant transmission, the controller 112 controls the node 102 to transmit a PHY header 402 according to the normal transmission rules outlined in 802.11, 802.11(a), 802.11(b) and 802.11(g) and to refrain from transmitting the indicated MAC header 404, data portion 406 and FCS 408 of an 802.11 compliant frame immediately after the PHY header 402. Instead, the controller 112 controls the node 102 (the transmitting node) to transmit the desired waveform not complying with 802.11 immediately after the PHY header 402 for a period of time not to exceed the duration indicated in the PLCP header 412 of the PHY header 402, that is, the duration of time represented by the value in the LENGTH field 424. Successful reception and decoding of the PHY header 402 by any 802.11 compliant node 102, 106 or 107 within the broadcast range of the transmitting node 102 will thus cause those 802.11 compliant nodes 102, 106 and 107 to refrain from accessing the transmission medium for the duration of time indicated in the PLCP header 412. That is, any 802.11 compliant node 102, 106 and 107 that has successfully received the PHY header 402 and is thus within the broadcast range of the transmitting node 102 and will not transmit any 802.11 compliant waveforms on the transmission medium. Accordingly, the transmitting node 102 can transmit the non-802.11 waveforms on the transmission medium without the chance of collision with an 802.11 compliant waveform from another node 102, 106 and 107, and can therefore use these non-802.11 waveforms to perform, for example, time-of-flight ranging or other desired functionality.

As can be appreciated by one skilled in the art, time-of-flight measurement is done by sending a special waveform from a node (e.g., a node 102), that can be designated for reference purposes as “station 1” to another node that can be designated “station 2”, and a special reply waveform back from station 2 to station 1. The turn-around time for station 2 to receiving the waveform and then transmit the reply waveform is generally constant. However, if this turn-around time is variable, information pertaining to the turn-around time can be communicated from station 2 to station 1 in some manner, for example, in the reply waveform. Further details of an example of time-of-flight measurement is described in U.S. Pat. No. 6,728,545 of John M. Belcea, the entire content of which is incorporated herein by reference. Accordingly, the embodiment of the present invention described above enables node 102 to reserve the transmission medium for the entire time-of-flight measurement transaction by transmitting the 802.11 compliant waveform to capture channel and then reserving the channel for the predetermined time designated by the LENGTH field 424 in the PHY header 402 so that the node 102 (station 1) can transmit the special waveform to another node 102, 106 or 107 (station 2) and then receive the reply waveform from that node 102, 106 or 107. As described in U.S. Pat. No. 6,728,545, the round trip time from the time of transmission of the waveform from node 102 (station 1) to the receipt of the reply waveform at node 102 (station 1) is measured and used as the basis for the time-of-flight calculation.

As can be appreciated by one skilled in the art, the embodiment of the present invention described herein is applicable for devices operating under the 802.11(g) specification and all future 802.11 technologies that require that a device receiving a PHY header 402 designate the transmission medium as busy for the duration of time indicated in a LENGTH field 424 of the PHY header 402 after successful reception of the PHY header 402, regardless of whether or not the receiving device has lost the carrier.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for controlling communication between nodes in a communication network, the method comprising:
controlling a first node to transmit a header of a signal complying with a particular protocol over a transmission medium;
controlling any of the nodes that received the header from the first node to refrain from transmitting another signal complying with the particular protocol over the transmission medium during a period of time designated in the received header; and
controlling the first node to transmit a signal not complying with the particular protocol over the transmission medium after transmitting the header and during the period of time designated in the header.

2. A method as claimed in claim 2, further comprising the step of:
during the period of time designated in the header, controlling the first node to receive a reply signal not complying with the particular protocol transmitted from one of the nodes in the network in response to receipt of the non-compliant signal that was transmitted from the first node; and
controlling the first node to calculate a time-of-flight measurement based on the time of its transmission of the non-compliant signal to the time of its receipt of the non-compliant reply signal.

3. A method as claimed in claim 1, wherein:
the header comprises a physical layer header that includes information representing the period of time.

4. A method as claimed in claim 3, wherein:
the particular protocol complies with the Institute of Electrical and Electronic Engineers (IEEE) 802.11 specification, and the physical layer header comprises a length field including the information representing the period of time.

5. A method as claimed in claim 1, further comprising:
controlling said any of the nodes to transmit a signal complying with the particular protocol over the transmission medium after the period of time designated in the received header has elapsed.

6. A method as claimed in claim 1, wherein:
the communication network comprises a wireless multi-hopping network, and the nodes are adapted to communicate in the wireless multi-hopping network.

7. A communication network, comprising:
a first node, adapted to transmit a header of a signal complying with a particular protocol over a transmission medium;
a plurality of other nodes, adapted to receive the header from the first node and, upon receiving the header, to refrain from transmitting another signal complying with the particular protocol over the transmission medium during a period of time designated in the received header; and
the first node being further adapted to transmit a signal not complying with the particular protocol over the transmission medium after transmitting the header and during the period of time designated in the header.

8. A communication network as claimed in claim 7, wherein:
during the period of time designated in the header, the first node is adapted to receive a reply signal not complying with the particular protocol that was transmitted from one of the other nodes in the network in response to receipt of the non-compliant signal that was transmitted from the first node; and
the first node is further adapted to calculate a time-of-flight measurement based on the time of its transmission of the non-compliant signal to the time of its receipt of the non-compliant reply signal.

9. A communication network as claimed in claim 8, wherein:
the header comprises a physical layer header that includes information representing the period of time.

10. A communication network as claimed in claim 9, wherein:
the particular protocol complies with the Institute of Electrical and Electronic Engineers (IEEE) 802.11 specification, and the physical layer header comprises a length field including the information representing the period of time.

11. A communication network as claimed in claim 7, wherein:
the other nodes are further to transmit a signal complying with the particular protocol over the transmission medium after the period of time designated in the received header has elapsed.

12. A communication network as claimed in claim 7, wherein:
the communication network comprises a wireless multi-hopping network; and the first node and the other nodes are adapted to communicate in the wireless multi-hopping network.

13. A node, adapted for communicating in a communication network, the node comprising:
a transceiver; and
a controller, adapted to control the transceiver to transmit a header of a signal complying with a particular protocol over a transmission medium, and to transmit a signal not complying with the particular protocol over the transmission medium after transmitting the header and during a period of time designated in the header.

14. A node as claimed in claim 13, wherein:
the controller is further adapted to, during the period of time designated in the header, control the transceiver to receive a reply signal not complying with the particular protocol that was transmitted from another node in the network in response to receipt of the non-compliant signal that was transmitted from the transceiver, and is further adapted during the period of time to calculate a time-of-flight measurement based on the time of its transmission of the non-compliant signal to the time of receipt of the non-compliant reply signal.

15. A node as claimed in claim 13, wherein:
the header comprises a physical layer header that includes information representing the period of time.

16. A node as claimed in claim 15, wherein:
the particular protocol complies with the Institute of Electrical and Electronic Engineers (IEEE) 802.11 specification, and the physical layer header comprises a length field including the information representing the period of time.

17. A node as claimed in claim 13, wherein:
the controller is further adapted to control the transceiver to receive another header of another signal complying with the particular protocol that was transmitted from another node in the communication network, and to control the transceiver to refrain from transmitting a signal complying with the particular protocol over the transmission medium during a period of time designated in the received another header.

18. A node as claimed in claim 13, wherein:
the controller is further adapted to allow the transceiver to transmit another signal complying with the particular protocol over the transmission medium after the period of time designated in the received header has elapsed.

19. A node as claimed in claim 13, wherein:
the communication network comprises a wireless multi-hopping network, and the transceiver is adapted to communicate in the wireless multi-hopping network.

20. A node as claimed in claim 13,
wherein the signal complying with the particular protocol further comprises a media access control header and data; and
the controller is further adapted to control the transceiver to refrain from transmitting the media access control header and data after transmitting the header and while transmitting the signal not complying with the particular protocol.
